(19) United States
(12) Patent Application Publication
(10) Pub. No.: US 2025/0223513 A1
(43) Pub. Date: Jul. 10, 2025

(54) CANDLE WAX COMPOSITIONS

(71) Applicant: CARGILL, INCORPORATED, Wayzata, MN (US)

(72) Inventors: Todd L. KURTH, Maple Grove, MN (US); Timothy Alan MURPHY, Albertville, MN (US); Yijun ZHOU, Maple Grove, MN (US)

(73) Assignee: CARGILL, INCORPORATED, Wayzata, MN (US)

(21) Appl. No.: 18/850,428

(22) PCT Filed: Mar. 30, 2023
(86) PCT No.: PCT/US2023/016939

§ 371 Date: Sep. 24, 2024

Related U.S. Application Data
(60) Provisional application No. 63/362,134, filed on Mar. 30, 2022.

(51) Int. Cl. C11C 5/00; C11C 3/08

(52) U.S. Cl. CPC C11C 5/002; C11C 3/08

(57) ABSTRACT

The present invention provides a wax formulation that includes about 5 weight percent (wt %) to about 85 wt % of a natural oil-based petrolatum composition based on total weight of the wax formulation; and about 1 wt % to about 95 wt % of a wax material based on total weight of the wax formulation; wherein the natural oil-based petrolatum composition a triglyceride component containing a plurality of hydroxyl containing fatty acid chains and wherein a plurality of the hydroxyl containing fatty acid chains are esterified with a C8-C22 branched or straight chain fatty acid and wherein the natural oil-based petrolatum composition has a drop melting point measured by AOCS Standard Procedure Cc 18-80 of between 35 and 70° C.

### CROSS-REFERENCE TO RELATED APPLICATIONS

This application claims the benefit of U.S. Provisional Application No. 63/362,134, filed Mar. 30, 2022, which is incorporated by reference herein in its entirety.

### TECHNICAL FIELD

This application relates to wax formulations, candle wax compositions and methods of making the same. In particular, this application relates to wax formulations and compositions that include natural oil based-petrolatum compositions.

### BACKGROUND

Natural waxes (namely beeswax) and petroleum-based waxes (namely paraffin wax) have been commonly used in to produce candles and other wax-based products. Paraffin, which replaced the more cost effective alternative to beeswax, became the primary industrial wax used to produce candles over a hundred years ago. Paraffin is produced from the residue left over from refining gasoline and motor oil, in connection with the petroleum refining industry.

There have been many efforts to replace petroleum based waxes with vegetable alternatives. Though many examples of vegetable based wax alternatives exist, there remains a need for suitable alternatives that have improved flexibility and utilities in specific candle applications.

Accordingly, it continues to be advantageous to have wax products, including candles, that have reduced amounts of petroleum-based ingredients and particularly including improved natural based materials that more closely mimic the texture, viscosity, stability, and melting profiles across a broad range of applications. Use a natural oil-based petrolatum like composition is one examples. Further, it would be environmentally and economically desirable if such materials were biodegradable and derived from renewable raw materials, such as natural oils.

### SUMMARY

The present disclosure provides a wax formulation that includes about 5 weight percent (wt %) to about 85 wt % of a natural oil-based petrolatum composition based on total weight of the wax formulation; and about 1 wt % to about 95 wt % of a wax material based on total weight of the wax formulation; wherein the natural oil-based petrolatum composition includes a triglyceride component wherein: the triglyceride component contains a plurality of hydroxyl containing fatty acid chains and wherein a plurality of the hydroxyl containing fatty acid chains are esterified with a C8-C22 branched or straight chain fatty acid and wherein the natural oil-based petrolatum composition has a drop melting point measured by AOCS Standard Procedure Cc 18-80 of between 30 and 70 degrees C.

The present disclosure provides a wax formulation that includes about 5 wt % to about 85 wt % of a natural oil-based petrolatum composition based on total weight of the wax formulation; and about 1 wt % to about 95 wt % of a wax material based on total weight of the wax formulation; wherein the natural oil-based petrolatum composition includes a triglyceride component wherein: the triglyceride component contains a plurality of hydroxyl containing fatty acid chains and wherein a plurality of the hydroxyl containing fatty acid chains are esterified with a C8-C22 branched or straight chain fatty acid and wherein the natural oil-based petrolatum composition contains less than 10% combined monoglycerides and diglycerides.

The present disclosure provides a wax formulation that include about 5 wt % to about 85 wt % of a natural oil-based petrolatum composition based on total weight of the wax formulation; and about 1 wt % to about 95 wt % of a wax material based on total weight of the wax formulation; wherein the natural oil-based petrolatum composition includes a triglyceride component wherein: the triglyceride component contains a plurality of hydroxyl containing fatty acid chains and wherein a plurality of the hydroxyl containing fatty acid chains are esterified with a C8-C22 branched or straight chain fatty acid and wherein the natural oil-based petrolatum composition: a) contains less than 10% combined monoglycerides and diglycerides, and b) has a drop melting point measured by AOCS Standard Procedure Cc 18-80 of between 35 and 70 degrees C.

The present disclosure provides a wax formulation that includes about 5 wt % to about 85 wt % of a natural oil-based petrolatum composition based on total weight of the wax formulation; and about 1 wt % to about 95 wt % of a wax material based on total weight of the wax formulation; wherein the natural oil-based petrolatum composition includes an esterification product of a pre-esterification mixture comprising a triglyceride component; wherein: the triglyceride component contains a plurality of hydroxyl containing fatty acid chains and wherein a plurality of the hydroxyl containing fatty acid chains are esterified with a C8-C22 branched or straight chain fatty acid and wherein the triglyceride component: a) contains less than 10% combined monoglycerides and diglycerides, and b) has a drop melting point measured by AOCS Standard Procedure Cc 18-80 of between 35 and 70° C.

The present disclosure further provides a method of making a wax formulation as described herein. The method includes heating the wax material to a temperature wherein the wax material is in a molten state; and combining the wax material in a molten state with a natural oil-based petrolatum composition as described herein.

The present disclosure provides a candle wax composition that includes a wax formulation as described herein.

The present disclosure provides a candle that includes a wick in a candle wax composition as described herein.

Advantages, some of which are unexpected, are achieved by aspects of the present disclosure. For example, various formulations and compositions described herein advantageously improve fragrance throw.

As a further advantage, various aspects of the present disclosure described herein are natural oil-based and thus have the advantage of comprising biodegradable, renewable, and environmentally-friendly components. For example, the wax formulations of the present disclosure can be prepared from natural-based components (e.g., natural oil-based petrolatum and natural oil-based waxes) and yet can offer the above-described advantages.

### DETAILED DESCRIPTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter. One aspect described in conjunction with a particular aspect is not necessarily limited to that aspect and can be practiced with any other aspect(s).

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used herein, the singular forms “a,” “an,” and “the” and similar referents in the context of describing the elements (especially in the context of the following claims) include plural referents unless the context clearly dictates otherwise. For example, reference to “a substituent” encompasses a single substituent as well as two or more substituents, and the like. It is understood that any term in the singular may include its plural counterpart and vice versa, unless otherwise indicated herein or clearly contradicted by context.

The term “or” is used to refer to a nonexclusive “or” unless otherwise indicated. The statement “at least one of A and B” has the same meaning as “A, B, or A and B.”

In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Any publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

As used herein, the terms “for example,” “for instance,” “such as,” or “including” are meant to introduce examples that further clarify more general subject matter. Unless otherwise specified, these examples are provided only as an aid for understanding the applications illustrated in the present disclosure, and are not meant to be limiting in any fashion.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, plus or minus within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the following terms have the following meanings unless expressly stated to the contrary.

As used herein, the term “natural oil” may refer to oil derived from plants or animal sources. The term “natural oil” includes natural oil derivatives (such as oils having undergone saponification, transesterification, esterification, interesterification, hydrogenation (partial or full), isomerization, fractionation, oxidation, and reduction), unless otherwise indicated. Examples of natural oils include, but are not limited to, vegetable oils, algae oils, animal fats, tall oils, derivatives of these oils, combinations of any of these oils, and the like. Representative non-limiting examples of vegetable oils include canola oil, rapeseed oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard oil, camelina oil, pennycress oil, hemp oil, algal oil, jojoba oil, and castor oil. Representative non-limiting examples of animal fats include lard, tallow, poultry fat, yellow grease, and fish oil. Tall oils are by-products of wood pulp manufacture. In any aspect, the natural oil may be refined, bleached, and/or deodorized. In any aspect, the natural oil is present individually or as mixtures thereof.

As used herein, the term “hydrogenated natural oil” refers to partial, complete, or substantially complete hydrogenation of a natural oil. Partial or substantially complete hydrogenation of natural oils is well known in the art and many hydrogenated natural oils may be purchased on the market and are available from a variety of commercial sources.

The natural oil may be an “interesterified natural oil(s)”. As used herein, the term “interesterification” or “interesterified” refers to a method of rearranging and redistributing the fatty acid on the glycerol fragment of triglycerides present in the natural oil. The rearrangement and redistribution does not change the overall composition of the fatty acids on the starting materials. Interesterification of an edible oil may be carried out chemically or enzymatically.

As used herein, a “natural oil-based” composition means that the composition contains oils and fatty acids which are predominantly, substantially or entirely, derived from natural oils and natural oil derivatives. The natural oil-based composition may, in various aspects, contain oils which are at least 50%, 55%, 60%, 65%, 70%, 75%, 80%, 85%, 90%, 95%, 99%, 99.9%, 99.99% or about 100% natural oil or hydrogenated natural oil.

A “monoacylglyceride” refers to a molecule having a glycerol moiety with a single fatty acid residue that is linked via an ester bond. The terms “monoacylglycerol,” “monoacylglyceride,” “monoglyceride,” and “MAG” are used interchangeably herein. Monoacylglycerides include 2-acylglycerides and 1-acylglycerides.

A “diacylglyceride” refers to a molecule having a glycerol moiety having two fatty acid residues linked via ester bonds. The terms “diacylglycerol,” “diacylglyceride,” “diglyceride,” and “DAG” are used interchangeably herein. Diacylglycerides include 1,2-diacylglycerides and 1,3-diacylglycerides.

A “triacylglyceride” refers to a molecule having a glycerol moiety that is linked to three fatty acid residues via ester bonds. The terms “triacylglycerol,” “triacylglyceride,” “triglyceride,” and “TAG” are used interchangeably herein.

The term “fatty acid” as used herein can refer to a molecule comprising a hydrocarbon chain and a terminal carboxylic acid group. As used herein, the carboxylic acid group of the fatty acid may be modified or esterified, for example as occurs when the fatty acid is incorporated into a glyceride or another molecule (e.g., COOR, where R refers to, for example, a carbon atom). Alternatively, the carboxylic acid group may be in the free fatty acid or salt form (i.e., COO⁻ or COOH). The ‘tail’ or hydrocarbon chain of a fatty acid may also be referred to as a fatty acid chain, fatty acid sidechain, or fatty chain. The hydrocarbon chain of a fatty acid will typically be a saturated or unsaturated aliphatic group. A fatty acid having N number of carbons, will typically have a fatty acid side chain having N−1 carbons. However, the subject application also relates to modified forms of fatty acids and thus the term fatty acid may be used in a context in which the fatty acid has been substituted or otherwise modified as described. For example, in various aspects, a fatty acid may be substituted with another alkyl chain (as is the case for isostearic acid or a hydroxy group as is the case with castor oil.

An “acylglyceride” refers to a molecule having at least one glycerol moiety with at least one fatty acid residue that is linked via an ester bond. For example, acylglycerides can include monoacylglycerides, diacylglycerides, triacylglycerides. The group acylglycerides can be further refined by additional descriptive terms and can be modified to expressly exclude or include certain subsets of acylglycerides. For example, the phrase mono- and di-acylglycerides refers to MAGs (monoacylglycerides) and DAGs (diacylglycerides), while the phrase non-MAG/non-DAG acylglycerides refers to a group of acylglycerides which exclude MAGs and DAGs.

A “fatty acid residue” is a fatty acid in its acyl or esterified form.

The levels of particular types of fatty acids may be provided herein in percentages out of the total fatty acid content of an oil. Unless specifically noted otherwise, such percentages are weight percentages based on the total fatty acids, including free fatty acids and esterified fatty acids as calculated experimentally.

A “saturated” fatty acid is a fatty acid that does not contain any carbon-carbon double bonds in the hydrocarbon chain. An “unsaturated” fatty acid contains one or more carbon-carbon double bonds. A “polyunsaturated” fatty acid contains more than one such carbon-carbon double bond while a “monounsaturated” fatty acid contains only one carbon-carbon double bond. Carbon-carbon double bonds may be in one of two stereoconfigurations denoted cis and trans. Naturally-occurring unsaturated fatty acids are generally in the “cis” form.

Non-limiting examples of fatty acids include C8, C10, C12, C14, C16 (e.g., C16:0, C16:1), C18 (e.g., C18:0, C18:1, C18:2, C18:3, C18:4), C20 and C22 fatty acids. For example, the fatty acids can be caprylic (8:0), capric (10:0), lauric (12:0), myristic (14:0), palmitic (16:0), stearic or isostearic (18:0), oleic (18:1), linoleic (18:2) and linolenic (18:3) acids.

The term “C8-C22 fatty acid” means a fatty acid containing 8-22 carbons. The C8-C22 fatty acid may be straight or branched and may be substituted with additional substituent groups such as a C1-C3 alkyl group or a hydroxyl group. In any aspect, the C8-C22 fatty acid has a straight chain. In any aspect, the C8-C22 fatty acid is a C16 or C18 fatty acid. In any aspect, the C8-C22 fatty acid is stearic acid.

The C8-C22 fatty acid may be a mixture of C8-C22 fatty acids. Stearic acid is commercially available in a variety of purities. It may be sold as 1890, meaning 90% C18 (stearic) containing. The remainder is typically comprised of other fatty acids, predominately C16. Alternatively, stearic can be sold as 1845 (or 1655); meaning approximately 45% stearic and 55% palmitic.

In any aspect, the C1-C3 alkyl substituent may be selected from methyl, ethyl, or propyl. In any aspect, the C1-C3 alkyl substituent may be methyl. The C8-C22 fatty acid substituted with one or more C1-C3 alkyl substituents, in any aspect described herein, may be isopalmitic acid, isomyristic acid, isosteric acid, 19-methylarachidic acid, isolauric acid.

The fatty acid composition of an oil can be determined by methods well known in the art. The American Oil Chemist's Society (AOCS) maintains analytical methods for a wide variety of tests performed on vegetable oils. Hydrolysis of the oil's components to produce free fatty acids, conversion of the free fatty acids to methyl esters, and analysis by gas-liquid chromatography (GLC) is the universally accepted standard method to determine the fatty acid composition of an oil sample. The AOCS Procedure Ce 1-62 describes the procedure used.

The terms “esterification or esterified” means the creation of an ester bond including: 1) the dehydration reaction of an alcohol with an acid; 2) transesterification, the reaction of an alcohol with an ester to form a new ester; or 3) interesterification, the rearrangement of fatty acids within a triacylglycerol structure.

A “drop point” or “dropping point” generally refers to the temperature at which a material (such as a wax) softens and becomes sufficiently fluid to flow as determined under the conditions of a given standardized test. As used herein, drop points are determined via AOCS Standard Procedure Cc 18-80. (Official Methods and Recommended Practices of the American Oil Chemists' Society, 7th Edition). Drop point is similar to melting point in that it reflects the thermal characteristics of a compound, however, drop point can be useful in defining materials which do not have a defined melting point. In any aspect, the natural oil-based petrolatum exhibits a melt drop point of about 35° C. to about 70° C. In any aspect, the natural oil-based petrolatum exhibits a melt drop point of about 35° C. to about 50° C.

The term “isostearic acid” as used herein refers to the chemical 16-methylheptadecanoic acid, which is a methyl-branched fatty acid that is heptadecanoic acid substituted by a methyl group at position 16. Isostearic acid is a lightly-branched, liquid fatty acid which can be produced by the reaction of oleic acid with a natural mineral catalyst. Isosteric acid is used in applications which require a liquid fatty acid with stability: thermal stability in the case of a lubricant, odor stability for a cosmetic formulation, and oxidation stability for products with long shelf-life requirements. The branching structure of isostearic acid also enhances its dispersing power, and it is used in cosmetic and industrial applications for the stabilization of pigments and mineral particles in oils and solvents. Isosteric acid is well known and commercially available. As used here in the term isosteric acid refers to a composition that comprises substantially all isosteric acid but need not be 100% pure.

The term “Polydispersity Index” (also known as “Molecular Weight Distribution”) as used herein is the ratio of weight average molecular weight (Mw) to number average molecular weight (Mn). The polydispersity data is collected using a Gel Permeation Chromatography instrument equipped with a Waters 510 pump and a 410 differential refractometer. Samples are prepared at an approximate 2% concentration in a THF solvent. A flow rate of 1 ml/minute and a temperature of 35° C. are used. The columns consist of a Phenogel 5 micron linear/mixed Guard column, and 300×7.8 mm Phenogel 5 micron columns (styrene-divinylbenzene copolymer) at 50, 100, 1000, and 10000 Angstroms. Molecular weights were determined using the following standards:

| Standard | Mono-olein | Diolein | Arcol LHT 240 | Trio-lein |
|---|---|---|---|---|
| Mol. Weight | 356 | 620 | 707 | 878 |
| (Daltons) | | | | |
| | Epoxidized | Acclaim | | Acclaim |
| Standard | Soybean Oil | 2200 | Mult-ranol 3400 | 8200 |
| Mol. Weight | 950 | 2000 | 3000 | 8000 |
| (Daltons) | | | | |

The term “weight average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using the test described herein or through size exclusion chromatography, light scattering, small angle neutron scattering, X-ray scattering, and sedimentation velocity.

The term “number average molecular weight” as used herein refers to Mₙ, which is equal to the total weight of the sample divided by the number of molecules in the sample. Mₙ, can be represented by the formula ΣMᵢnᵢ/nᵢ, where nᵢ is the number of molecules of molecular weight Mᵢ.

The term “Acid Value” (AV) as used herein is defined as the weight of KOH in mg needed to neutralize the organic acids present in 1 g of test sample and it is a measure of the free fatty acids present in the composition. AV can be determined by the AOCS Official Method Cd 3d-63. The acid value of the compositions described herein may be less than 20.0, or less than 10.0, or less than 4.0, or between 0.5 and 20.0, or between 0.5 and 10.0, or between 0.5 and 4.0.

The term “Hydroxyl Value” as used herein is defined as the hydroxyl value, expressed in milligrams of potassium hydroxide and corresponds to the number of hydroxyl groups present in 1 g of a sample, is one of the traditional characteristics of oils and fats. Hydroxyl Value may be determined by AOCS Standard Method Cd 13-60. The compositions described herein may have a hydroxyl value of less than 90 or less than 50. In any aspect, the composition may have a hydroxyl value of between 10 and 90 or between 10 and 50. In any aspect, the composition may have a hydroxyl value of between 20 and 50 or between 25 and 40.

The term “Iodine Value” (commonly abbreviated as IV) as used herein is the mass of iodine in grams that is consumed by 100 grams of a chemical substance. Iodine numbers are often used to determine the amount of unsaturation in fats, oils and waxes. In fatty acids, unsaturation occurs mainly as double bonds which are very reactive towards halogens, iodine in this case. Thus, the higher the iodine value, the more unsaturation is present in the sample. The Iodine Value of a material can be determined by the standard well-known Wijs method (A.O.C.S. Cd1-25).

### Wax Formulation

The formulation provided herein is useful in the manufacture of wax formulations such as candle wax or other wax products. The inventors unexpectedly found that wax formulations comprising a natural oil-based petrolatum have numerous desirable characteristics as explained further below and can be used to replace all or part of the petroleum based petrolatum currently used in wax formulations.

The present disclosure provides a wax formulation that includes about 5 wt % to about 85 wt % of a natural oil-based petrolatum composition based on total weight of the wax formulation; and about 1 wt % to about 95 wt % of a wax material based on total weight of the wax formulation; wherein the natural oil-based petrolatum composition includes a triglyceride component wherein: the triglyceride component comprises a mixture of triglycerides and wherein the mixture of triglycerides comprises individual triglycerides comprising one or more ester containing fatty acids and wherein the esters of the ester containing fatty acids are C8-C22 branched or straight chain fatty acid esters and wherein the composition has a drop melting point measured by AOCS Standard Procedure Cc 18-80 of between 30° and 70° C.

The present invention provides a wax formulation that includes about 5 wt % to about 85 wt % of a natural oil-based petrolatum composition based on total weight of the wax formulation; and about 1 wt % to about 95 wt % of a wax material based on total weight of the wax formulation; wherein the natural oil-based petrolatum composition includes a triglyceride component wherein: the triglyceride component comprises a mixture of triglycerides and wherein the mixture of triglycerides comprises individual triglycerides comprising one or more ester containing fatty acids and wherein the esters of the ester containing fatty acids are C8-C22 branched or straight chain fatty acid esters and wherein the composition contains less than 10% combined monoglycerides and diglycerides.

The present technology provides a wax formulation that include about 5 wt % to about 85 wt % of a natural oil-based petrolatum composition based on total weight of the wax formulation; and about 1 wt % to about 95 wt % of a wax material based on total weight of the wax formulation; wherein the natural oil-based petrolatum composition includes a triglyceride component wherein: the triglyceride component contains a plurality of hydroxyl containing fatty acid chains and wherein a plurality of the hydroxyl containing fatty acid chains are esterified with a C8-C22 branched or straight chain fatty acid and wherein the natural oil-based petrolatum composition: a) contains less than 10% combined monoglycerides and diglycerides, and b) has a drop melting point measured by AOCS Standard Procedure Cc 18-80 of between 35 and 70 degrees C.

In any aspect, the wax formulation as described herein includes about 5 wt % to about 85 wt % of the natural oil-based petrolatum composition, based on total weight of the wax formulation. For example, the natural oil-based petrolatum composition may be present in the wax formulation in amounts of about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, or any range including and/or in between any two of the preceding values. In any aspect, the wax formulation may include the natural oil-based petrolatum composition in an amount of about 5 wt % to about 85 wt %, 15 wt % to about 85 wt %, about 20 wt % to about 85 wt %, about 20 wt % to about 80 wt %, about 25 wt % to about 75 wt %, about 10 wt % to about 60 wt %, about 15 wt % to about 50 wt %, about 18 wt % to about 28 wt %, or any range including and/or in between any two of the preceding values.

The triglyceride component of the natural oil-based petrolatum composition may be prepared by the skilled artisan for example by epoxidizing natural oils containing unsaturated fatty acids and ring opening the epoxides. This chemistry is well known in the fats and oils art. Alternatively, the triglyceride component of the natural oil-based petrolatum composition may naturally contain hydroxy groups. Some natural oils contain hydroxy fatty acids in their native state. Castor oil is one such example. Typically, castor oil is comprised of approximately 70%-90% ricinoleic acid fatty acid residues. The triglyceride component of the natural oil-based petrolatum composition may be partially, substantially, or completely hydrogenated. Good quality castor oil has a hydroxyl value of approximately 160. Fully hardened or hydrogenated castor oil typically has a minimal hydroxyl value of 150.

Procedures for preparing the natural oil-based petrolatum composition as described in the present disclosure are tailored to minimize the amount of transesterification and interesterification that occurs during the reaction. Excessive transesterification can create hydroxystearic oligomers and high molecular weight structures as well as unwanted MAGs and DAGs. In some aspects, the natural oil-based petrolatum compositions contain less than 10% combined MAGs and DAGs. In some aspects, the natural oil-based petrolatum compositions contain less than 10% combined MAGs and DAGs. In some aspects, the natural oil-based petrolatum compositions contain between 0.5% and 10% combined MAGs and DAGs. In some aspects, the natural oil-based petrolatum compositions contain between 1% and 8% combined MAGs and DAGs. The content of MAGs and DAGs in the natural oil-based petrolatum composition can be determined routinely by those of skill in the art. Size exclusion chromatography or GPC as described above can be used to determine molecular weight and correspondingly fractions of a composition that are mono-, di-, or triglycerides. A skilled artisan will appreciate that a standard curve can be created and used to celebrate the specific chromatography equipment.

In any aspect, the triglyceride component of the natural oil-based petrolatum composition is hydrogenated. In any aspect, the triglyceride component of the natural oil-based petrolatum composition comprises hydrogenated castor oil.

In any aspect, the reaction mixture (i.e., pre-esterification mixture) for preparing the natural oil-based petrolatum composition comprises an additional natural or hydrogenated natural oil.

In any aspect, the additional natural oil is hydrogenated soybean or hydrogenated coconut oil.

The natural oil-based petrolatum composition may include minimal amounts of free fatty acids. For example, the natural oil-based petrolatum composition may include less than about 2 wt % free fatty acids. In any aspect, the natural oil-based petrolatum composition may include less than about 1 wt %, less than about 2.5 wt % free fatty acids, or between 0.1 wt % and 2.5 wt % fatty acids.

The natural oil-based petrolatum composition may include minimal amounts of combined monoglycerides and diglycerides. For example, the natural oil-based petrolatum composition may include less than about 10 wt % of combined monoglycerides and diglycerides. In any aspect, the natural oil-based petrolatum composition may include less than about 8 wt %, about 6 wt %, less than about 5 wt %, or less than about 3 wt % of combined monoglycerides and diglycerides. In any aspect, the natural oil-based petrolatum composition may include between about 1% to about 10 wt %; or between about 1% to about 7 wt %; or between about 2% to about 7 wt %; of combined monoglycerides and diglycerides.

The iodine value of the natural oil-based petrolatum compositions described herein may be less than about 10.0, less than about 5.0, less than about 3.0, or in between about 0.1 to about 3.0. Suitable iodine values as described herein in any aspect may include about 0.1, about 0.5, about 1.0, about 1.5, about 2.0, about 2.5, about 3.0, about 3.5, about 4.0, about 4.5, about 5.5, about 6.0, about 6.5, about 7.0, about 7.5, about 8.0, about 8.5, about 9.0, about 9.5, about 10.0, or any range including and/or in between any two of the preceding values.

The natural oil-based-petrolatum composition, as described herein in any aspect, may include one or more of the following: (i) an acid value of less than about 20.0; (ii) between about 2% to about 7 wt %; of combined monoglycerides and diglycerides, or (iii) an iodine value of less than about 3.0. In any aspect, the natural oil-based-petrolatum composition may have two, or all three, of the preceding characteristics.

Unlike waxes or hard fats, the natural oil-based petrolatum composition described herein can be a semisolid material that can hold its own shape but deflects under pressure more similar to a grease or shortening. Resistance to deflection under pressure can be determined though use of a cone penetration test. Cone penetration can be measured by use of standard methodology ASTM D217-2.

The natural oil-based petrolatum composition exhibits a combination of rheological properties that provides for comparable spreading and tackiness to petroleum-based petrolatum. In any aspect disclosed herein, the natural oil-based petrolatum exhibits one or more rheological properties selected from a melt drop point of about 35° C. to about 70° C., a cone penetration at 25° C. of greater than 20 or from about 20 to about 100 or from about 60 to about 90 (Dmm ( 1/10 of mm), kinetic viscosity at 100° C. of about 5 mm²/s to about 35 mm²/s, a congealing point of about 25° C. to about 45° C., or combinations thereof.

The natural oil-based petrolatum composition can be prepared according to a method of making that includes mixing a fatty acid and a triglyceride component containing one or more hydroxyl containing fatty acid chains and optionally a hydrogenated natural oil, heating the mixture to an elevated temperature, (optionally in the presence of an acid catalyst) and exposing the heated mixture to pressure below ambient pressure to yield a product wherein a plurality of the hydroxyl containing fatty acid chains are esterified with a C8-C22 branched or straight chain fatty acid and wherein the triglyceride component: a) contains less than 10% combined monoglycerides and diglycerides and b) has a drop melting point measured by AOCS Standard Procedure Cc 18-80 of between 35 and 70° C. and isolating the natural oil-based petrolatum composition.

The reaction may be monitored in a number of different ways depending on the properties sought. If allowed to proceed, the reaction will reach a certain steady state point where a form of equilibrium is achieved. At this point, the parameters of the product will not be significantly changing and continued reaction time will encourage degradation to affect the quality of the product. Alternatively, the reaction may be allowed to proceed to a certain set point such as acid value, hydroxyl value, or until a certain drop melting point is achieved. This is in the discretion of the operator. In some aspects, the reaction is allowed to proceed until the reaction mixture reaches an acid value of less than 20.0, or less than 10, or less than 5, or until the reaction mixtures reaches an acid value of less 4.0 so as to provide a natural oil-based petrolatum composition. In some aspects, that reaction mixture reaches an acid value between 0.5 and 20.0. In some aspects, that reaction mixture reaches an acid value between 0.5 and 10.

The reaction mixture has the natural oil-based petrolatum composition as described herein and the mixture is treated to induce chemical or enzymatic esterification by methods well known in the art. Procedures of the present disclosure, including the use of vacuum and limited catalysts, are tailored to minimize the amount of transesterification and interesterification that occurs during the reaction. Excessive transesterification an create hydroxystearic oligomers and high molecular weight structures as well as unwanted MAGs and DAGS.

To carry out chemical esterification, a catalyst can be added at an amount of about 0.1 wt % relative to the reaction mixture of ingredients. Example catalysts can be acids such methanesulfonic acid or bases such as sodium hydroxide and calcium hydroxide, or metal catalysts. In any aspect, methanesulfonic acid is the catalyst. Hypophosphoric acid can optionally be added to the reaction mixture to prevent formation of off colors. The reaction temperature can then be increased to about 140-250° C. Typically, a reaction temperature of 160° C. is utilized. This reaction temperature is maintained for a period of time and the reaction vessel is subjected to vacuum of between 20 and 50 torr until a desired endpoint or steady state is reached. In any aspect, to an acid value of less than 15 or less than 10 or less than 5 is achieved or a polydispersity index of greater than 1.3 is obtained. A base, for example a mineral base such as sodium hydroxide or calcium hydroxide, can be added at an amount of about 0.2 wt % to neutralize the catalyst with a slight excess. The reaction mixture can then be cooled to a temperature ranging from about 60-80° C. A filter media, for example acid activated beaching clay such as B80 neutral or Trisyl® silica, can be added to the reaction mixture in an amount of about 2 wt % or less relative to the reaction mixture to remove impurities. The final product, i.e., the natural oil-based petrolatum composition, is then filtered to remove the salts, silica, or clay mixture. In some aspects, the catalyst for preparing the natural oil-based petrolatum composition is selected from the group of bases, acids, metals, or combinations thereof. In some aspects, the catalyst for preparing the natural oil-based petrolatum composition is an acid catalyst or combination of acid catalysts.

Alternatively, to carry out enzymatic transesterification, an enzymatic catalyst can be added at an amount of 2 wt % relative to the reaction mixture. An example enzymatic catalyst can be Lipase Novozyme 435. A vacuum of about 50 torr can be used to remove water as the reaction is taking place. A reaction temperature ranging from about 60-80° C. is maintained until an acid value of less than 5.0 is achieved or a polydispersity index of greater than 1.3 is obtained. The enzymatic catalyst can then be filtered out using an appropriate filter device to obtain the final product, i.e., the natural oil-based petrolatum composition.

Alternatively, esterification can be performed without a catalyst. A reaction mixture of a C8-C22 branched or straight chain fatty acid and a hydrogenated natural oil such as castor oil, are pre-melted and heated to a temperature ranging from 60-80° C. before adding to a reaction vessel along with a nitrogen sparge to prevent oxidation. A vacuum of between 20 and 50 torr is applied to the reaction vessel and the temperature increased to 180-250° C. The acid value of the reaction is monitored, and the reaction temperature and vacuum are maintained until an acid value of less than 20 is achieved. The product is isolated after cooling the reaction mixture to 60-80 degrees and filtering (such as through a sock filter) to remove any particulates.

In any aspect, the wax formulation as described herein includes about 1 wt % to about 95 wt % of the wax material, based on total weight of the wax formulation. For example, the wax material may be present in the wax formulation in amounts of about 1 wt %, about 2.5 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, or any range including and/or in between any two of the preceding values. In any aspect, the wax formulation may include the wax material in an amount of about 2.5 wt % to about 90 wt %, about 5 wt % to about 80 wt %, about 10 wt % to about 65 wt %, about 15 wt % to about 55 wt %, about 25 wt % to about 95 wt %, about 35 wt % to about 90 wt %, or about 50 wt % to about 85 wt %.

The wax material may be any prior art wax known to those of skill in the art. For example, suitable wax materials may include, but are not limited to, creature waxes (such as beeswax), petroleum-based waxes (such as paraffin wax), plant-based waxes, natural oil-based waxes, or mixtures thereof. In any aspect, the wax material may include beeswax, paraffin wax, natural oil-based waxes, or mixtures thereof. In any aspect, the wax material may be a natural oil-based wax. The natural oil-based wax may be a flexible wax composition. In any aspect, the wax material may be a flexible wax, wherein the flexible wax includes about 20 wt % to about 45 wt % monoacylglycerides, about 28 wt % to about 40 wt % diacylglycerides, and about 10 wt % to about 45 wt % acylglyceride polymers, wherein the acylglyceride polymers are compounds containing one or more dimerized fatty acid residue and a plurality of glycerol moieties. In any aspect, the flexible wax composition may include about 40 wt % to about 75 wt % monoacylglycerides and diacylglycerides having a weight average molecular weight of about 200 Da to about 580 Da, and at least 10 wt % acylglycerides having a weight average molecular weight of about 900 Da to about 3000 Da. Suitable flexible wax compositions for use in the present wax formulations are described in U.S. Patent Application Publication No. 2021/0062003 entitled “FLEXIBLE WAX AND METHOD OF MAKING THE SAME,” filed Jan. 14, 2019, the entire contents of which are hereby incorporated by reference. Suitable natural oil-based waxes for use in the present wax formulations are further described in U.S. Pat. No. 7,217,301, entitled “TRIACYLGLYCEROL-BASED ALTERNATIVE TO PARAFFIN WAX,” filed Sep. 5, 2003, and U.S. Pat. No. 11,008,532, entitled “WAX COMPOSITIONS AND THE EFFECT OF METALS ON BURN RATES,” their entire contents of which are hereby incorporated by reference.

The wax material may further include creature waxes such as lanolin, shellac wax, Chinese insect wax, and spermaceti, various types of plant waxes such as carnauba, candelilla, Japan wax, ouricury wax, rice-bran wax, jojoba wax, castor wax, bayberry wax, sugar cane wax, and maize wax, and synthetic waxes such as polyethylene wax, Fischer-Tropsch wax, chlorinated naphthalene wax, chemically modified wax, substituted wax, montan wax, alpha olefins and polymerized olefin wax.

The wax formulation of the present technology exhibits a melt point in the range of about 100° F. (˜37.8° C.) to about 150° F. (˜65.6° C.), or preferably about 110° F. (˜43.3° C.) to about 140° F. (60° C.). For example, the wax formulation may exhibit a melt point of about 100° F. (˜37.8° C.), about 105° F. (˜40.6° C.), about 110° F. (˜43.3° C.), about 115° F. (˜46.1° C.), about 120° F. (˜48.9° C.), about 125° F. (˜51.7° C.), about 130° F. (˜54.4° C.), about 135° F. (˜57.2° C.), about 140° F. (60° C.), about 145° F. (˜62.8° C.), about 150° F. (˜65.6° C.), or any range including and/or in between any two of the preceding values.

The wax formulation may further include natural oils as described herein. For example, the wax formulation may include about 0 wt % to about 85 wt % of the natural oil based on total weight of the wax formulation. Suitable amounts of the natural oils may include about 5 wt % to about 85 wt %, about 20 wt % to about 80 wt %, about 25 wt % to about 75 wt %, about 25 wt % to about 55 wt %, or any range including and/or in between any two of the preceding values. In any aspect, the natural oils present in the wax formulation may be interesterified natural oils, hydrogenated natural oils, or combinations thereof. In any aspect, the natural oils present in the wax formulation may be interesterified natural oils (e.g., interesterified coconut oil, interesterified soybean oil, interesterified canola oil, interesterified palm oil, interesterified rapeseed oil, and the like).

The wax formulation is well suited for use as a candle wax, particularly for container candles. The wax formulation, when formulated for use in candle wax or other wax products containing scenting agents, surprisingly exhibit improved fragrance throw. As used herein, the term “fragrance throw” or “scent throw” refers to the release of aroma from a wax product (e.g., candles) containing scenting agents. Generally, the terms “fragrance throw” or “scent throw” encompass both hot throw (i.e., release of aroma when the candle is burning) and cold throw (i.e., release of aroma when the candle is not lit or heated).

The wax formulation, when formulated for use in candle wax or other wax products, also has the proper surface adhesion characteristics so the wax does not pull away from the container when cooled. The wax formulation may also exhibit reduced or no cracking when formulated for use in candle wax or other wax products. Additionally, the present wax formulation may provide a consistent, even appearance when resolidified and does not exhibit undesirable mottling in the candle which results from uneven wax crystallization.

In an aspect, the present disclosure also provides a method for preparing a wax formulation as described herein in any aspect, the method includes:
heating the wax material to a temperature wherein the wax material is in a molten state; and
combining the wax material in a molten state with a natural oil-based petrolatum composition;
wherein the natural oil-based petrolatum composition includes a triglyceride component as described herein in any aspect.

In an additional aspect, the present disclosure provides a wax formulation prepared according to the method as described herein.

### Compositions

The wax formulations of the present disclosure can be utilized in the preparation of various compositions (e.g., candle wax or other wax products).

In an aspect, the present disclosure provides a candle wax composition that includes a wax formulation as described herein in any aspect. The wax formulation includes about 5 wt % to about 85 wt % of a natural oil-based petrolatum composition as described herein in any aspect based on total weight of the wax formulation; and about 1 wt % to about 95 wt % of a wax material based on total weight of the wax formulation.

The candle wax composition may include about 1 wt % to 100 wt % of the wax formulation based on total weight of the candle wax composition. Preferably, the candle wax composition may include about 5-70 wt %, about 50-99%, about 75-95%, about 20-90%, about 20-80%, about 1-30%, about 2-20%, or about 1-15% of the wax formulation based on total weight of the candle wax composition. Suitable amounts of the wax formulation present in the candle wax composition may include about 1 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 99 wt %, 100 wt %, or any range including and/or in between any two of the preceding values.

Candle wax compositions containing the wax formulation of the present disclosure may optionally contain additional ingredients to tailor the needs of the particular application. A skilled artisan will readily appreciate the range of additives available to suit this purpose including but not limited to the following: wax-fusion enhancing additives, coloring agents, scenting agents, migration inhibitors, free fatty acids, surfactants, co-surfactants, emulsifiers, additional optimal wax ingredients, monoglycerides, diglycerides, distilled monoglycerides, or mixtures thereof.

A skilled artisan would appreciate that one or more additives as described herein may be present in various concentrations depending on the needs of the particular candle wax composition. In any aspect, the candle wax composition may include about 0.1 wt % to about 30 wt % of the one or more additives based on total weight of the candle wax composition. For example, the one or more additives may be included in the candle wax composition in amounts of about 0.1 wt %, about 0.5 wt %, about 1 wt %, about 5 wt %, about 10 wt %, about 15 wt %, about 20 wt %, about 25 wt %, about 30 wt %, or any range including and/or in between any two of the preceding values.

Suitable wax-fusion enhancing additives may include, but are not limited to, benzyl benzoate, dimethyl phthalate, dimethyl adipate, isobornyl acetate, cellulose acetate, glucose pentaacetate, pentaerythritol tetraacetate, trimethyl-s-trioxane, N-methylpyrrolidone, polyethylene glycols and mixtures thereof. Typically, the candle wax composition may include about 0.1 wt % to about 5 wt % of the wax-fusion enhancing additive based on total weight of the candle wax composition.

Suitable coloring agents (i.e., dyes or pigments) may be included in the candle wax composition in amounts of about 0.001 wt % to about 2 wt % based on total weight of the composition. For example, the coloring agent may be present in amounts of about 0.001 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, or any range including and/or in between any two of the preceding values. The coloring agents may be added to the candle wax composition to provide a desired hue to the composition. If a pigment is employed as a coloring agent, it is typically an organic toner in the form of a fine powder suspended in a liquid medium, such as a mineral oil. It may be advantageous to use a pigment that is in the form of fine particles suspended in a natural oil as described herein. Coloring agents suitable for use in candle wax compositions are known to those of skill in the art. For example, a variety of pigments and dyes suitable for use in the candle wax composition of the present technology are described in U.S. Pat. No. 4,614,625, the entire contents of which are hereby incorporated by reference. In any aspect, the carrier for use with organic dyes is an organic solvent, such as a relatively low molecular weight, aromatic hydrocarbon solvent (e.g., toluene and xylene).

Suitable scenting agent additives may include one or more perfumes, fragrances, essences, or other aromatic oils which may be added to provide a desired aroma or odor to the candle wax composition. For example, the scenting agent may include, but is not limited to, air fresheners, insect repellents, or mixtures thereof. In any aspect, the air freshener may be a liquid fragrance that includes one or more volatile organic compounds, including those commercially available from perfumery suppliers such as: IFF, Firmenich Inc., Takasago Inc., Belmay, Symrise Inc., Noville Inc., Quest Co., and Givaudan-Roure Corp. Most conventional fragrance materials are volatile essential oils. The fragrance can be a synthetically formed material, or a naturally derived oil such as oil of bergamot, bitter orange, lemon, mandarin, caraway, cedar leaf, clove leaf, cedar wood, geranium, lavender, orange, origanum, petitgrain, white cedar, patchouli, lavandin, neroli, rose, and the like. The scenting agent can also be a liquid formulation containing an insect repellent such as citronellal, or a therapeutic agent such as eucalyptus or methanol.

Additionally or alternatively, in any aspect described herein the scenting agent may be selected from a wide variety of chemicals including, but not limited to, aldehydes, ketones, esters, alcohols, terpenes, and the like. The scenting agent can be relatively simple in composition, or can be a complex mixture of natural and synthetic chemical components. The scenting agent may include scented oils. A typical scented oil may include woody/earthy bases containing exotic constituents such as sandalwood oil, civet, patchouli oil, and the like. A scented oil can have a light floral fragrance such as rose extract or violet extract. Scented oil also can be formulated to provide desirable fruity odors, such as lime, lemon, or orange.

The scenting agent may include synthetic type of fragrance composition either alone or in combination with natural oils such as described in U.S. Pat. Nos. 4,314,915; 4,411,829; and 4,434,306; their entire contents of which are hereby incorporated by reference. Other suitable scenting agents may include artificial liquid fragrances including, but not limited to, geraniol, geranyl acetate, eugenol, isoeugenol, linalool, linalyl acetate, phenethyl alcohol, methyl ethyl ketone, methylionone, isobornyl acetate, and the like.

In any aspect, the candle wax composition of the present technology containing a scenting agent as described herein may further exhibit improved fragrance throw.

In any aspect, a “migration inhibitor” additive may be included in the candle wax composition to decrease the tendency of colorants, fragrance components, and/or other components of the candle wax composition from migrating to the outer surface of a candle. For example, the migration inhibitor may be a polymerized alpha olefin. In any aspect, the polymerized alpha olefin has at least 10 carbon atoms. In any aspect, the polymerized alpha olefin may have between 10 and 25 carbon atoms. For example, one suitable polymer is a hyper-branched alpha olefin polymer sold under the trade name Vybar® 103 polymer (mp 168° F.; ˜76° C.); commercially available form Baker-Petrolite, Sugarland, TX, USA).

Other suitable migration inhibitor additives may include sorbitan triesters, such as sorbitan tristearate and/or sorbitan tripalmitate, and related sorbitan triesters formed from mixtures of fully hydrogenated fatty acids, and/or polysorbate triesters or monoesters such as polysorbate tristearate and/or polysorbate tripalmitate and related polysorbates formed from mixtures of fully hydrogenated fatty acids in the candle wax composition may also decrease its chances of cracking during the cooling processes that occur in candle formation and after extinguishing the flame of a burning candle.

In any aspect, the candle wax composition may include about 0.1 wt % to about 5 wt % of the migration inhibitor based on total weight of the candle wax composition. Preferably, the migration inhibitor additive may be present in an amount of about 0.1 wt % to about 2 wt %.

In any aspect, the candle wax composition may include an additional optimal wax ingredient, including but not limited to, creature waxes such as beeswax, lanolin, shellac wax, Chinese insect wax, and spermaceti, various types of plant waxes such as carnauba, candelilla, Japan wax, ouricury wax, rice-bran wax, jojoba wax, castor wax, bayberry wax, sugar cane wax, and maize wax, and synthetic waxes such as polyethylene wax, Fischer-Tropsch wax, chlorinated naphthalene wax, chemically modified wax, substituted wax, montan wax, alpha olefins and polymerized olefin wax. In any aspect, the candle wax composition may include about 1 wt % to about 25 wt %, or preferably 1 wt % to about 10 wt %, of the optimal wax ingredient additive.

In any aspect, the candle wax composition may include about 1 wt % to about 15 wt % of the scenting agent based on total weight of the candle wax composition. For example, the scenting agent may be present in amounts of about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, or any range including and/or in between any two of the preceding values. The coloring and scenting agents generally may also include liquid carriers that vary depending upon the type of color- or scent-imparting ingredient employed. In any aspect, the use of liquid organic carriers with coloring and scenting agents is preferred because such carriers are compatible with petroleum-based waxes and related organic materials. As a result, such coloring and scenting agents tend to be readily absorbed into the candle wax composition.

The candle wax composition may include a surfactant. In any aspect, the candle wax composition may include about 1 wt % to about 25 wt %, or preferably about 1 wt % to about 10 wt %, of the surfactant based on total weight of the candle wax composition. Suitable surfactants for use in the candle wax composition may include, but are not limited to, polyoxyethylene sorbitan trioleate, such as Tween 85, commercially available from Acros Organics; polyoxyehtylene sorbitan monooleate, such as Tween 80, commercially available from Acros Organics and Uniqema; sorbitan tristearate, such as DurTan65, commercially available from Loders Croklann, Grindsted STS 30 K commercially available from Danisco, and Tween 65 commercially available from Acros Organics and Uniqema; sorbitan monostearate, such as Tween 60 commercially available from Acros Organics and Uniqema, DurTan 60 commercially available from Danisco; Polyoxyethylene sorbitan monopalmitate, such as Tween 40, commercially available from Acros Organics and Uniqema; and polyoxyethylene sorbitan monolaurate, such as Tween 20, commercially available from Acros Organics and Uniqema.

Additionally, the candle wax composition may include a co-surfactant, which may be added, for example, to improve the microstructure (texture) and/or stability (shelf-life) of emulsified wax compositions. In any aspect, the candle wax composition may include about 0.1 wt % to about 5 wt % of the co-surfactant based on total weight of the candle wax composition. The candle wax composition may optionally include an emulsifier. Emulsifiers for waxes are commonly synthesized using a base-catalyzed process, after which the emulsifiers may be neutralized. In any aspect, the emulsifier may be neutralized by adding organic acids, inorganic acids, or combinations thereof to the emulsifier. Non-limiting examples of organic or inorganic acids include citric acid, phosphoric acid, hydrochloric acid, nitric acid, sulfuric acid, lactic acid, oxalic acid, carboxylic acid, as well as other phosphates, nitrates, sulfates, chlorides, iodides, nitrides, and combinations thereof.

In another aspect, the present disclosure provides a candle that includes a wick in a candle wax composition as described herein. The candle may be in any desired shape. Depending on the type of candle being produced, the candle may be unmolded or used as a candle while still in the mold. Examples of the latter include votive candles and decorative candles, such as those designed to be burned in a clear glass container. The candle may optionally include one or more additives as described herein.

Candles can be produced from the candle wax composition using a number of methods. In one common process, the candle wax composition is heated to a molten state. If additives as described herein (e.g., colorants and/or scenting agents) are in included in the candle formulation, these may be added to the molten candle wax composition or mixed with the wax formulation prior to heating. The molten candle wax composition is then commonly solidified around a wick. When the candle wax composition of the present technology is used as a candle, the same standard wicks that are used with other waxes can be utilized. For example, the molten candle wax composition can be poured into a mold which includes a wick disposed therein. The molten candle wax composition is then cooled to solidify the wax in the shape of the mold. Depending on the type of candle being produced, the candled may be unmolded or used as a candle while still in the mold. Other methods for producing a candle are known to those of skill in the art. For example, suitable methods for producing candles of the present technology are described in U.S. Pat. No. 11,008,532, entitled “WAX COMPOSITIONS AND THE EFFECT OF METALS ON BURN RATES,” their entire contents of which are hereby incorporated by reference.

The present technology, thus generally described, will be understood more readily by reference to the following examples, which are provided by way of illustration and are not intended to be limiting of the present invention.

### Examples

TABLE 1

| Materials | Source |
|---|---|
| Stearic Acid (TRV 1890) | Twin Rivers |
| Stearic Acid (TRV 1655) | Technology |
| Fully Hydrogenated Castor Oil (HCO) | Acme Hardesty |
| Hydrogenated Soybean Oil (HSO) | Cargill Incorporated |

TABLE 2

| | Example | | | | | |
|---|---|---|---|---|---|---|
| | 1A | 2A | 2B | 2C | 2D | 1B |
| | Acid | No | No | No | No | Acid |
| | catalyzed | catalyst | catalyst | catalyst | catalyst | catalyzed |
| HCO* | 81 | 76 | 71 | 64 | 66 | 61 |
| Stearic | 19 | 24 | 29 | 36 | 34 | 29 |
| Acid | | | | | | |
| 1890* | | | | | | |
| HSO* | — | — | — | — | — | 10 |
| OH Value | 85 | 85 | 75 | 47 | 53 | 34 |
| Acid | 2 | 7 | 17 | 18 | 17 | 4 |
| Value | | | | | | |
| MDP° C. | 33.55 | 60.4 | 61 | 40.17 | 47.78 | 36.8 |
| % MAG | 3.93 | 1.38 | 1.78 | 1.21 | 0.97 | 1.34 |
| % DAG | 1.64 | 0.87 | 1.61 | 1.69 | 3.46 | 6.04 |

*Amounts of HCO, Stearic acid, and HSO are % by weight of the reaction mixture.

### Example 1 (Preparation of Natural Oil-Based Petrolatum Composition):

The following chemical esterification method was carried out to make Examples 1A and 1B. All components or oils as described in Table 2 were pre-melted and heated to 80° C. before adding to the reaction vessel under a nitrogen sparge. The agitator was turned on to mix the contents. If used, hypophosphoric acid was added at 0.2% dosage and methanesulphonic acid was added at 0.1% dosage. Once all ingredients were added and well mixed the temperature was increased to approximately 160° C. Acid value is monitored throughout the reaction and once AV is <20 or change in AV is less than 1 unit per hour, vacuum is applied to the reaction vessel to achieve a pressure of approximately 30 torr. The reaction temperature was maintained until an acid value of 5 or less was achieved. The reaction was then cooled to approximately 85° C. and calcium hydroxide solution was added to neutralize the catalyst with a slight excess. The mixture was cooled to 70° C. and Trisyl® silica was added to the reaction at 1% and allowed to absorb the salts from the catalyst. The product was then filtered to remove the salts and clay mixture as well as other impurities

The following chemical esterification method was carried out to purposefully limit transesterification and prepared Examples 2A-2D. All components or oils as described in Table 2 were pre-melted and heated to 80° C. before adding to the reaction vessel under a nitrogen sparge to keep the product from oxidizing during the reaction. The agitator was turned on to mix the contents. Hypophosphoric acid was added at 0.2% dosage. Once all ingredients were added and well mixed the temperature was increased to approximately 180° C. and vacuum of approximately 20-30 torr is applied to the reaction vessel. Acid value is monitored throughout the reaction. The reaction temperature and vacuum were maintained until an acid value of 20 or less was achieved. The reaction was then cooled to approximately 85° C. and filtered through a sock filter to remove any particulates.

### Example 2 (Preparation of Natural Oil-Based Petrolatum Compositions):

The following chemical esterification method was carried out to purposefully limit transesterification in preparation of Examples 2A-2D. All components or oils as described in Table 2 were pre-melted and heated to approximately 80° C. before adding to the reaction vessel under a nitrogen sparge to keep the product from oxidizing during the reaction. The agitator was turned on to mix the contents. If used, hypophosphoric acid was added at 0.2% dosage. Once all ingredients were added and well mixed the temperature was increased to approximately 180° C. and vacuum is applied to the reaction vessel to achieve a pressure of approximately 20-30 torr. Acid value is monitored throughout the reaction. The reaction temperature and vacuum was maintained until an acid value of 20 or less was achieved. The reaction was then cooled to approximately 85° C. and filtered through a sock filter to remove any particulates.

### Example 3 (Natural Oil-Based Petrolatum Compositions):

TABLE 3

| | Example | | | | | | | | | | | |
|---|---|---|---|---|---|---|---|---|---|---|---|---|
| | 3A | 3B | 3C | 3D | 3E | 3F | 3H | 3I | 3J | 3K | 3L | 3M |
| | No | No | Acid | No | Acid | No | No | Acid | Acid | No | No | No |
| | catalyst | catalyst | catalyst | catalyst | catalyst | catalyst | catalyst | catalyst | catalyst | catalyst | catalyst | catalyst |
| Scale (g) | 1350 | 1400 | 1400 | 75500 | 1400 | 1400 | 1400 | 600 | 1350 | 3525 | 650 | 650 |
| Run Time (hrs) | 28 | 26 | 11 | 14 | 12 | 11 | 16 | 9 | 6 | 13 | | 42 |
| HCO* | 80% | 66% | 66% | 66% | 66% | 71% | 64% | 81% | 78% | 78% | 90% | 65% |
| Stearic Acid 1655* | 20 | | | | | | | | | 22% | 10% | 35% |
| Stearic Acid 1890* | | 34% | 34% | 34% | 34% | 29% | 36% | 19% | 22% | | | |
| OH Value | 63.471 | 46.9 | 27.6 | 53.2 | 55.0 | 75.1 | 47.4 | 84.6 | 76.8 | 84.2 | 123.8 | 31 |
| Acid Value | 1.24 | 7.4 | 2.9 | 17.3 | 17.6 | 17.0 | 17.5 | 2.1 | 2.2 | 4.9 | 5 | 4.7 |
| MDP° C. | 38.1 | 34.1 | 35.4 | 47.8 | 33.4 | 61.0 | 40.2 | 33.6 | 57.6 | 52.5 | 74.7 | 29.8 |
| RXN comments | ** | ** | ** | *** | *** | ** | ** | ** | ** | ** | ** | ** |

*Amounts of HCO and Stearic acid are % by weight of the reaction mixture.
** Reaction is run until essentially completion or equilibrium where values are not changing dramatically.
*** Reaction is run until a certain AV is achieved.

Examples 3A-M were prepared as represented in Table 3. They were run at different scales, for different times and utilized either a catalyst free or acid catalyst system as described in Examples 1 and 2. The reaction was allowed to either continue until a stable state where equilibrium is reached or were run until an acid value of less that 18 was reached.

### Example 4 (Natural Oil-Based Petrolatum Composition):

TABLE 4

| | Example | | | | | |
|---|---|---|---|---|---|---|
| | 4A | 4B | 4C | 4D | 4E | 4F |
| | No | Acid | No | Acid | Acid | Acid |
| | catalyst | catalyst | catalyst | catalyst | catalyst | catalyst |
| Scale (g) | 500 | 600 | 3500 | 1360 | 1350 | 1350 |
| Run Time (hrs) | 27 | 7 | 12.5 | 6 | 8 | 11 |
| HCO* | 76% | 76% | 77% | 76% | 76% | 76% |
| Stearic Acid 1890* | 24% | 24% | 23% | 24% | 24% | 24% |
| OH Value | 83.0 | 73.1 | 75.6 | 67.7 | 68.0 | 59.0 |
| Acid Value | 7.2 | 2.4 | 4.8 | 2.5 | 2.6 | 1.7 |
| MDP° C. | 58.7 | 39.0 | 48.2 | 57.7 | 39.8 | 33.1 |
| RXN comments | 180° C. to | 160° C. to | 200° C. to | 160° C. to | 160° C. to | No |
| | equib | set AV | set AV | equib | equib | vacuum |
| | Vacuum <30 | then | then | vacuum <20 | vacuum | |
| | torr | vacuum | vacuum | torr | approx. | |
| | for entire | of <30 | of <30 | for entire | 100 torr | |
| | reaction | torr | torr | reaction | for entire | |
| | | applied | applied | | reaction | |
| | | until | until | | | |
| | | equib | equib | | | |

*Amounts of HCO and Stearic acid are % by weight of the reaction mixture.

Examples 4A-F were prepared as represented in Table 4. They were run at different scales, for different times and utilized either a catalyst free or acid catalyst system as described in Examples 1 and 2. In addition, the degree and timing of the vacuum was varied. The reactions were typically allowed to continue until a stable state where equilibrium is reached or for an additional period of time. By varying the reactions conditions as shown the skilled artisan can manage the preference for the esterification of the hydroxy fatty acid vs transesterification of the triglyceride.

### Example 5 (Wax Formulation Compositions):

TABLE 5

| | Example | | | | | | | | | | |
|---|---|---|---|---|---|---|---|---|---|---|---|
| | 5A | 5B | 5C | 5D | 5E | 5F | 5G | 5H | 5I | 5J | 5K |
| Component | | | | | | | | | | | |
| Example 3K (natural oil-based petrolatum) | 25.00 | 25.00 | 25.00 | 25.00 | 50.00 | 25.00 | 25.00 | 25.00 | 80.00 | 25.00 | 25.00 |
| Interesterified Soy/Coconut Oil (wt %) | 72.50 | 70.00 | 65.00 | — | — | 75.00 | 45.00 | 50.00 | — | 37.50 | 30.00 |
| Flexible Natural oil-based Wax (wt %) | 2.50 | 5.0 | 10.0 | 26.25 | 17.50 | — | 30.00 | 25.00 | 20.00 | 37.50 | 45.00 |
| HSO (wt %) | — | — | — | 48.75 | 32.50 | — | — | — | — | — | — |
| Performance^{†} | | | | | | | | | | | |
| Pull Away* | 4 | 4 | 4 | 5 | 5 | 4 | 5 | 5 | 5 | 5 | 5 |
| Filming** | 4 | 4 | 4 | 5 | 2 | 5 | 4 | 2 | 5 | 5 | 5 |
| Fat Bloom*** | 1 | 2 | 3 | 4 | 5 | 2 | 4 | 3 | 5 | 5 | 5 |
| Top Appearance^{~} | 1 | 3 | 3 | 4 | 5 | 5 | 4 | 4 | 5 | 5 | 5 |
| Cracking^{≈} | 5 | 3 | 3 | 5 | 5 | 5 | 3 | 4 | 5 | 5 | 5 |
| Hardness^{‡} | 4 | 4 | 4 | 4 | 4 | 4 | 5 | 5 | 2 | 5 | 5 |
| Performance Score (out of 30) | 19 | 20 | 21 | 27 | 26 | 25 | 25 | 23 | 27 | 30 | 30 |

^{†}Counter Cool (ambient temperature; approx. 15-25° C.)
*1 (10% adhesion)-5 (total adhesion/pull away)
**1 (unacceptable)-5 (“beautiful”)
***1 (unacceptable)-5 (“beautiful”)
^{~}1 (unacceptable)-5 (“beautiful”)
^{≈}1 (excessive cracking)-5 (no cracking)
^{‡}1 (extremely soft)-5 (very hard)

The wax formulations in Table 5 for Examples 5A-K were prepared by first heating the flexible natural oil-based wax (as described in U.S. Patent Application Publication No. 2021/0062003), interesterified natural oil (i.e., interesterified soy/coconut oil), and/or HSO until a molten mixture is obtained. The natural oil-based petrolatum prepared according to Examples 1-4 was mixed into the molten wax mixture to obtain the wax formulations. Each wax formulation was counter cooled and evaluated for their performance in container candle applications. As shown in Table 5, Examples 5A-K showed acceptable over all performance, with Examples 5C-G and 51-K showing performance scores of 25 or above out of 30. Accordingly, the present examples demonstrate wax formulations having acceptable performance in container candle applications.

### Exemplary Aspects

The following exemplary aspects are provided, the numbering of which is not to be construed as designating levels of importance:

Para. A: A wax formulation comprising:
about 5 weight percent (wt %) to about 85 wt % of a natural oil-based petrolatum composition based on total weight of the wax formulation; and
about 25 wt % to about 95 wt % of a wax material based on total weight of the wax formulation;
wherein the natural oil-based petrolatum composition comprises a triglyceride component,
   wherein:
      the triglyceride component contains a plurality of hydroxyl containing fatty acid chains; and
      a plurality of the hydroxyl containing fatty acid chains are esterified with a C8-C22 branched or straight chain fatty acid; and
wherein the natural oil-based petrolatum composition has a drop melting point measured by AOCS Standard Procedure Cc 18-80 of between 35 and 70° C.

Para. B: The wax formulation of Para. A, wherein the natural oil-based petrolatum composition contains between 0.5% and 10% combined monoglycerides and diglycerides.

Para. C: The wax formulation of Para. A or Para. B, wherein some of the individual triglycerides present in the natural oil-based petrolatum composition contain more than one ester containing fatty acid.

Para. D: The wax formulation of any one of Paras. A-C, wherein the mixture of triglycerides present in the natural oil-based petrolatum composition contains 20% to 70% of ester containing fatty acids.

Para. E: The wax formulation of any one of Paras. A-D, wherein the C8-C22 branched or straight chain fatty acid esters comprise stearic acid and palmitic acid.

Para. F: The wax formulation of any one of Paras. A-E, wherein the C8-C22 branched or straight chain fatty acid esters consist essentially of stearic acid and palmitic acid.

Para. G: The wax formulation of any one of Paras. A-F, wherein the natural oil-based petrolatum composition comprises between 50% and 100% weight percent of the triglyceride component.

Para. H: The wax formulation of any one of Paras. A-G, wherein the natural oil-based petrolatum composition has an acid value between 0.5 and 20.

Para. I: The wax formulation of any one of Paras. A-H, wherein the natural oil-based petrolatum composition has a hydroxyl value between 10 and 90.

Para. J: The wax formulation of any one of Paras. A-I, wherein the natural oil-based petrolatum has acid value between 0.5 and 5.

Para. K: The wax formulation of any one of Paras. A-J, wherein the natural oil-based petrolatum has an iodine value of less than about 3.0.

Para. L: The wax formulation of any one of Paras. A-K, wherein the wax formulation comprises about 15 wt % to about 85 wt % of the natural oil-based petrolatum composition.

Para. M: The wax formulation of any one of Paras. A-L, wherein the wax formulation comprises about 10 wt % to about 65 wt % of the wax material.

Para. N: The wax formulation of any one of Paras. A-M, wherein the wax material comprises beeswax, paraffin wax, plant-based waxes, natural oil-based waxes, or mixtures thereof.

Para. O: The wax formulation of any one of Paras. A-N, wherein the wax material comprises natural oil-based waxes.

Para. P: The wax formulation of any one of Paras. A-O, wherein the wax formulation further comprises 0 wt % to about 85 wt % of natural oils based on total weight of the wax formulation.

Para. Q: The wax formulation of any one of Paras. A-P, wherein the wax formulation further comprises about 20 wt % to about 80 wt % of natural oils based on total weight of the wax formulation.

Para. R: The wax formulation of any one of Paras. A-Q, wherein the natural oils comprise interesterified natural oils, hydrogenated natural oils, or combinations thereof, preferably interesterified soybean oil, interesterified coconut oil, hydrogenated soybean oil, or combinations of two or more thereof.

Para. S: The wax formulation of any one of Paras. A-R, wherein the wax formulation has a melt point in the range of about 100° F. to about 150° F., preferably a melt point in the range of about 110° F. to about 140° F.

Para. T: The wax formulation of any one of Paras. A-S, wherein the wax formulation exhibits improved fragrance throw.

Para. U: The wax formulation of any one of Paras. A-T, wherein the wax formulation exhibits improved performance based on one or more of cracking, top appearance, pull away, hardness, filming, or fat bloom when formulated for use in candle wax applications.

Para. V: A candle wax composition comprising a wax formulation according to any one of Paras. A-U.

Para. W: The candle wax composition of Para. V, wherein the composition comprises about 1 wt % to 100 wt %, preferably about 5 wt % to about 70 wt %, of the wax formulation based on total weight of the candle wax composition.

Para. X: The candle wax composition of Para. V or Para. W further comprising an additive comprising wax-fusion enhancing additives, coloring agents, scenting agents, migration inhibitors, free fatty acids, surfactants, co-surfactants, emulsifiers, additional optimal wax ingredients, monoglycerides, diglycerides, distilled monoglycerides, or mixtures thereof.

Para. Y: The candle wax composition of any one of Paras. V-X, wherein the composition comprises about 0.1 wt % to about 30 wt % of the at least one additive based on total weight of the candle wax composition.

Para. Z: The candle wax composition of any one of Paras. V-Y, wherein the candle wax composition exhibits improved fragrance throw.

Para. AA: The candle wax composition of any one of Paras. V-Z, wherein the candle wax composition exhibits improved performance based on one or more of cracking, top appearance, pull away, hardness, filming, or fat bloom.

Para. AB: A candle comprising a wick in a candle wax composition, wherein the candle wax composition comprises:
a wax formulation comprising about 5 wt % to about 85 wt % of a natural oil-based petrolatum composition based on total weight of the wax formulation; and
about 1 wt % to about 95 wt % of a wax material based on total weight of the wax formulation;
wherein the natural oil-based petrolatum composition comprises an esterification product of a pre-esterification mixture comprising a triglyceride component,
   wherein:
      the triglyceride component contains a plurality of hydroxyl containing fatty acid chains; and
      a plurality of the hydroxyl containing fatty acid chains are esterified with a C8-C22 branched or straight chain fatty acid; and
wherein the natural oil-based petrolatum composition has a drop melting point measured by AOCS Standard Procedure Cc 18-80 of between 35 and 70° C.

Para. AC: The candle of Para. AB, wherein the natural oil-based petrolatum has an iodine value of about 0.1 to about 3.0.

Para. AD: The candle of Para. AB or Para. AC, wherein the wax formulation comprises about 15 wt % to about 85 wt % of the natural oil-based petrolatum composition.

Para. AE: The candle of any one of Paras. AB-AD, wherein the wax formulation comprises about 10 wt % to about 65 wt % of the wax material.

Para. AF: The candle of any one of Paras. AB-AE, wherein the wax material comprises beeswax, paraffin-based waxes, plant-based waxes, natural oil-based waxes, or mixtures thereof.

Para. AG: The candle of any one of Paras. AB-AF, wherein the wax material comprises natural oil-based waxes, preferably flexible natural oil-based waxes.

Para. AH: The candle of any one of Paras. AB-AG, wherein the wax formulation has a melt point in the range of about 100° F. to about 150° F., preferably a melt point in the range of about 110° F. to about 140° F.

Para. AI: The candle of any one of Paras. AB-AH, wherein the wax formulation further comprises 0 wt % to about 85 wt % of natural oils based on total weight of the wax formulation.

Para. AJ: The candle of any one of Paras. AB-AI, wherein the wax formulation further comprises about 20 wt % to about 80 wt % of natural oils based on total weight of the wax formulation.

Para. AK: The candle of any one of Paras. AB-AJ, wherein the natural oils comprise interesterified natural oils, hydrogenated natural oils, or combinations thereof, preferably interesterified soybean oil, interesterified coconut oil, hydrogenated soybean oil, or combinations of two or more thereof.

Para. AL: The candle of any one of Paras. AB-AK, wherein the candle wax composition comprises about 1 wt % to 100 wt % of the wax formulation.

Para. AM: The candle of any one of Paras. AB-AL further comprising an additive comprising wax-fusion enhancing additives, coloring agents, scenting agents, migration inhibitors, free fatty acids, surfactants, co-surfactants, emulsifiers, additional optimal wax ingredients, or mixtures thereof.

Para. AN: The candle of any one of Paras. AB-AM, wherein the candle exhibits improved fragrance throw, wherein the candle wax composition exhibits improved performance based on one or more of cracking, top appearance, pull away, hardness, filming, or fat bloom.

Para. AO: The candle of any one of Paras. AB-AN, wherein the candle wax composition exhibits improved performance based on one or more of cracking, top appearance, pull away, hardness, filming, or fat bloom.

Para. AP: A method for preparing a wax formulation according to any one of Paras. A-U, the method comprising:
heating the wax material to a temperature wherein the wax material is in a molten state; and
combining the wax material in a molten state with a natural oil-based petrolatum composition;
wherein the natural oil-based petrolatum composition comprising a triglyceride component,
   wherein:
      the triglyceride component contains a plurality of hydroxyl containing fatty acid chains; and
      a plurality of the hydroxyl containing fatty acid chains are esterified with a C8-C22 branched or straight chain fatty acid; and
wherein the natural oil-based petrolatum composition has a drop melting point measured by AOCS Standard Procedure Cc 18-80 of between 35 and 70° C.

Each of the non-limiting aspects above can stand on its own or can be combined in various permutations or combinations with one or more of the other aspects or other subject matter described in this document. While the invention has been illustrated and described in certain aspects, a person with ordinary skill in the art, after reading the foregoing specification can effect changes, substitutions of equivalents and other types of alterations to the present technology as set forth herein. Each aspect described above can also have included or incorporated therewith such variations or aspects as disclosed in regard to any or all of the other aspects.

The present technology is also not to be limited in terms of the particular aspects described herein, which are intended as single illustrations. Many modifications and variations of this present technology can be made without departing from its spirit and scope, as will be apparent to those skilled in the art from the foregoing descriptions. Such modifications and variations are intended to fall within the scope of the appended claims. It is to be understood that this present technology is not limited to particular methods, reagents, compounds, or compositions, which can, of course, vary. It is also to be understood that the terminology used herein is for the purpose of describing particular aspects only and is not intended to be limiting. Thus, it is intended that the specification be considered as exemplary only with the breadth, scope and spirit of the present technology indicated only by the appended claims, definitions therein and any equivalents thereof.

The aspects, illustratively described herein may suitably be practiced in the absence of any element or elements, limitation or limitations, not specifically disclosed herein. Thus, for example, the terms “comprising,” “including,” “containing,” etc. shall be read expansively and without limitations. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the invention. This includes the generic description of the invention with a proviso or negative limitation removing any subject matter form the genus, regardless of whether or not the excised material is specifically.

1. A wax formulation comprising:
about 5 weight percent (wt %) to about 85 wt % of a natural oil-based petrolatum composition based on total weight of the wax formulation; and
about 25 wt % to about 95 wt % of a wax material based on total weight of the wax formulation;
wherein the natural oil-based petrolatum composition comprises a triglyceride component,
wherein:
the triglyceride component contains a plurality of hydroxyl containing fatty acid chains; and
a plurality of the hydroxyl containing fatty acid chains are esterified with a C8-C22 branched or straight chain fatty acid; and
wherein the natural oil-based petrolatum composition has a drop melting point measured by AOCS Standard Procedure Cc 18-80 of between 35 and 70° C.

2. The wax formulation of claim 1, wherein the natural oil-based petrolatum composition contains between 0.5% and 10% combined monoglycerides and diglycerides.

3. The wax formulation of claim 1, wherein some of the individual triglycerides present in the natural oil-based petrolatum composition contain more than one ester containing fatty acid.

4. The wax formulation of claim 1, wherein the mixture of triglycerides present in the natural oil-based petrolatum composition contains 20% to 70% of ester containing fatty acids.

5. The wax formulation of claim 1, wherein the C8-C22 branched or straight chain fatty acid esters comprise stearic acid and palmitic acid.

6. The wax formulation of claim 1, wherein the C8-C22 branched or straight chain fatty acid esters consist essentially of stearic acid and palmitic acid.

7. The wax formulation of claim 1, wherein the natural oil-based petrolatum composition comprises between 50% and 100% weight percent of the triglyceride component.

8. The wax formulation of claim 1, wherein the natural oil-based petrolatum composition has an acid value between 0.5 and 20.

9. The wax formulation of claim 1, wherein the natural oil-based petrolatum composition has a hydroxyl value between 10 and 90.

10. The wax formulation of claim 1, wherein the natural oil-based petrolatum has acid value between 0.5 and 5.

11. The wax formulation of claim 1, wherein the natural oil-based petrolatum has an iodine value of less than about 3.0.

12. The wax formulation of claim 1, wherein the wax material comprises natural oil-based waxes.

13. The wax formulation of claim 1, wherein the wax formulation further comprises 0 wt % to about 85 wt % of natural oils based on total weight of the wax formulation.

14. The wax formulation of claim 12, wherein the natural oils comprise interesterified natural oils, hydrogenated natural oils, or combinations thereof.

15. The wax formulation of claim 1, wherein the wax formulation has a melt point in the range of about 100° F. to about 150° F.

16. A candle wax composition comprising a wax formulation according to claim 1.

17. The candle wax composition of claim 16, wherein the composition comprises about 1 wt % to 100 wt % of the wax formulation based on total weight of the candle wax composition.

18. The candle wax composition of claim 16 further comprising an additive comprising wax-fusion enhancing additives, coloring agents, scenting agents, migration inhibitors, free fatty acids, surfactants, co-surfactants, emulsifiers, additional optimal wax ingredients, monoglycerides, diglycerides, distilled monoglycerides, or mixtures thereof.

19. The candle wax composition of claim 18, wherein the composition comprises about 0.1 wt % to about 30 wt % of the at least one additive based on total weight of the candle wax composition.

20. A candle comprising a wick in a candle wax composition, wherein the candle wax composition comprises:
a wax formulation according to claim 1.

21. A method for preparing a wax formulation according to claim 1, the method comprising:
heating the wax material to a temperature wherein the wax material is in a molten state; and
combining the wax material in a molten state with a natural oil-based petrolatum composition;
wherein the natural oil-based petrolatum composition comprising a triglyceride component,
wherein:
the triglyceride component contains a plurality of hydroxyl containing fatty acid chains; and
a plurality of the hydroxyl containing fatty acid chains are esterified with a C8-C22 branched or straight chain fatty acid; and
wherein the natural oil-based petrolatum composition has a drop melting point measured by AOCS Standard Procedure Cc 18-80 of between 35 and 70° C.
